(19) United States
(12) Patent Application Publication
(10) Pub. No.: US 2017/0165819 A1
(43) Pub. Date: Jun. 15, 2017

(54) Soft Top Assist Tool

(71) Applicant: Floyd Gibbs, Newport News, VA (US)

(72) Inventor: Floyd Gibbs, Newport News, VA (US)

(21) Appl. No.: 14/966,454

(22) Filed: Dec. 11, 2015

(51) Int. Cl. B25B 27/00

(52) U.S. Cl. CPC B25B 27/0035

(57) ABSTRACT

A tool designed for use with vehicles having tops. The tool has two hook ends that are slidably connected, with a lever handle connection the two hook ends such that the two hook ends may be drawn together by operation of the lever handle. The tool is positioned with one hook in the tie-down hook of a Jeep windshield and the second hook disposed around the front bar of a soft top to be installed on the vehicle. As the lever handle is operated, the tool draws the soft top forward to the windshield, allowing a user to clamp the soft top to the windshield.

### FIELD OF THE INVENTION

The invention described herein relates to automotive accessories. In particular, the invention relates to accessories that may be used with Jeep and jeep-like vehicles that have removable soft tops. The present invention assists a user in reattaching a soft top onto a vehicle.

### BACKGROUND OF THE INVENTION

Jeeps and Jeep-brand vehicles have a long history and a strong following by people who like the particular style and capabilities of the vehicles. There is also a large desire and a strong market for jeep accessories, especially those geared towards enthusiasts who wish to add to the comfort and use of a jeep without compromising the nature of the jeep experience. Part of the enthusiasm for jeep use comes with the ability to remove portions of the vehicle, including the top, windows, and doors. There are many options for jeep tops, but one of the most popular remains a cloth or fabric top, commonly referred to as a “soft top.” Soft tops are light, easy to remove and stow, and are relatively inexpensive when compared to hard top options.

However, the reinstallation of a soft top can be problematic for many jeep users and owners. Especially when inclement weather conditions require the top to be placed back on the vehicle quickly. In order for a soft top to function as the vehicle is moving, it must be taught across the top of the jeep. If the top is not tightened adequately, wind over the vehicle can cause the top to ripple and move, ultimately wearing out the soft top or, in some cases, causing rips and other catastrophic failures.

In order to correctly fit a soft top to a jeep, the front portion of the soft top is attached at the top of the windshield utilizing clamps designed for that purpose. It is often difficult, however, especially for a single person, to stretch the soft top forward enough the be engaged in the clamps and simultaneously clamp the front of the soft top to the top of the windshield.

It would therefore be advantageous to have a tool that would assist a user in pulling the soft top towards the front of the vehicle to the top of the windshield, but with enough force to bring the soft top front edge close enough to the top of the windshield such that the clamps to hold the soft top to the windshield are easily engaged by one person using their free hand.

### SUMMARY OF THE INVENTION

The present invention is related to vehicle accessories and soft top installation tools. The present invention is directed to a portable mechanical lever that is small and easily carried with a vehicle. The present invention further is directed to a portable mechanical lever that utilizes mechanical advantage to assist a user in drawing a soft top tight against the top of the windshield of a vehicle, while allowing the user to easily engage the permanent clamps that hold the front edge of a soft top to the top of a vehicle's windshield.

It is therefore an object of the present invention to provide a portable device for vehicles that serves to pull the front of a soft top tight to the top of a windshield.

### BRIEF DESCRIPTION OF THE DRAWINGS

These and other embodiments are described by the following figures and detailed description.

FIG. 1 is a view of an embodiment of the present invention.

FIG. 2 is a top-down view of the present invention.

FIG. 3 is a side view of the present invention fully extended.

FIG. 4 is an oblique view of the present invention.

FIG. 5 is a side view of the present invention.

FIG. 6 is a view of the present invention in use inside a vehicle.

### DETAILED DESCRIPTION OF THE INVENTION

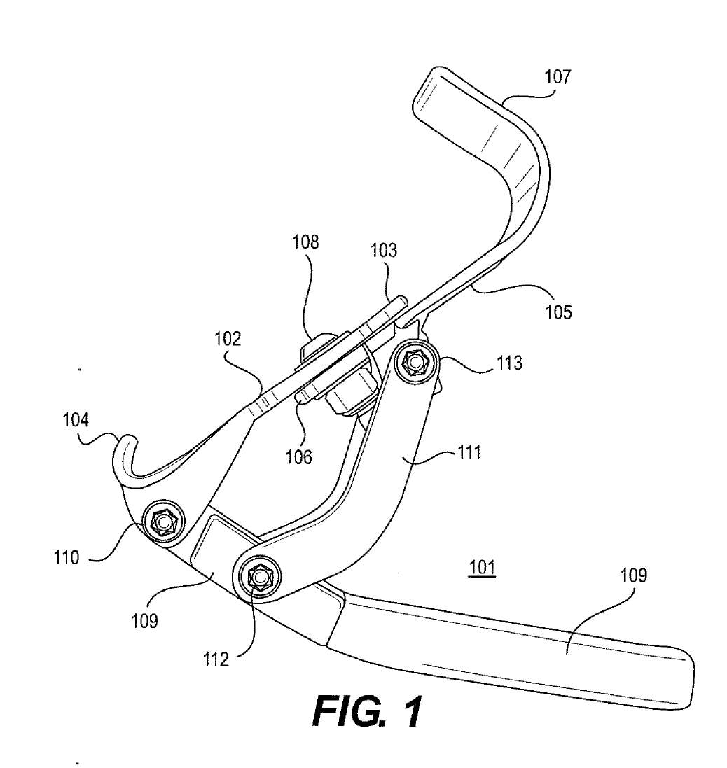

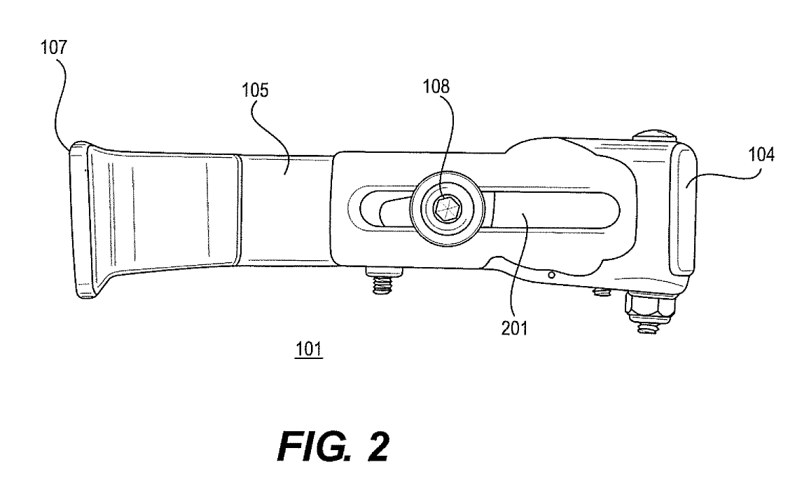

Referring now to FIG. 1, an embodiment of the present invention is shown. The top assist lever 101 comprises a first hook portion 102 and a second hook portion 105. The first hook portion 102 comprises a flat portion 103 and a hook end 104. The hook end 104 is configured to be of a size sufficient to engage the tie-down hook located on the top inside of the windshield frame that is standard on Jeep models with windshields that may be folded down and secured to the hood. The second hook portion 105 comprises a flat portion 106 and a hook end 107. The hook end 107 is of a size to position around the front bar (not shown) of a vehicle soft top. The second hook portion 105 is connected to the first hook portion 102 with a bolt 108. The bolt 108 is affixed to the second hook portion 105, and extends through a slot (FIG. 2, 201) in the flat portion 103 of the first hook portion 102. A lever handle 109 is pivotally connected 110 to the first hook portion 102. Two connectors 111 are pivotally connected 112 to the lever handle 109, and pivotally connected 113 to the second hook portion 105.

Referring now to FIG. 2, a top-down view of the top assist lever 101 is shown. The first hook portion 102 has a slot 201 through which the bolt 108 extends, joining the first hook portion 102 with the second hook portion 105 such that the first hook portion 102 can slide back and forth on the assembly of the bolt 108 and the second hook portion 105.

In FIG. 1, as the lever handle 109 is operated by pressing the lever handle 109 down in the direction of the second hook portion 105, the connectors 111 pivot and create lateral force on the second hook portion 105, causing the second hook portion 105 to slide away from the first hook portion 102, thereby increasing the distance between the first hook 104 and the second hook 107. As the lever handle 109 is operated such that it is extended away from the second hook portion 105, the connectors 111 pivot and draw the second hook portion 105 towards the first hook portion 102, thereby drawing the first hook 104 and the second hook 107 closer together. When the device is operated in this manner with the first hook 104 disposed in the tie-down hook of a jeep windshield and the second hook 107 positioned around the front bar of a soft top, operating the lever handle 109 to draw the first hook 104 and the second hook 107 together, the soft top is drawn towards the front of the vehicle thereby allowing the user to close the clamps that hold the soft top to the windshield.

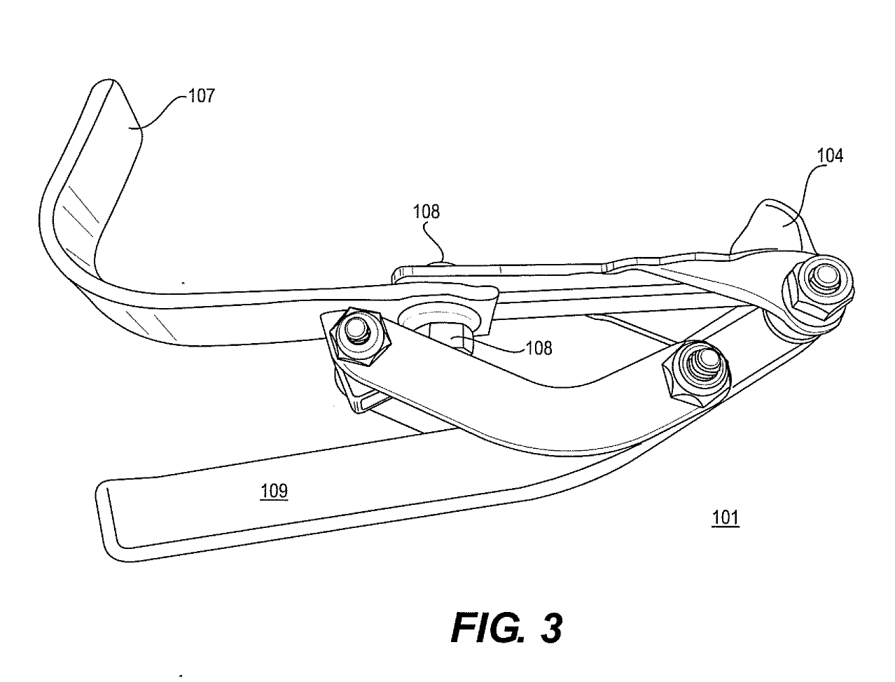

FIG. 3 is a side view of the device 101, showing the device fully extended with the first hook 104 and the second hook 107 at the farthest distance from each other.

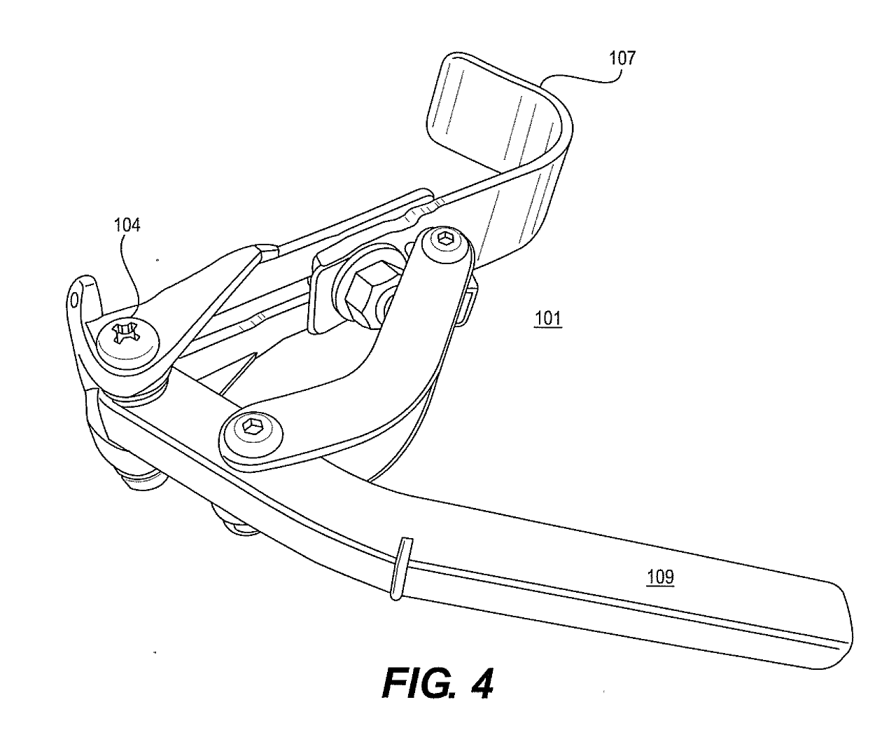

FIG. 4 is an oblique view of the present invention to further illustrate the details of the tool.

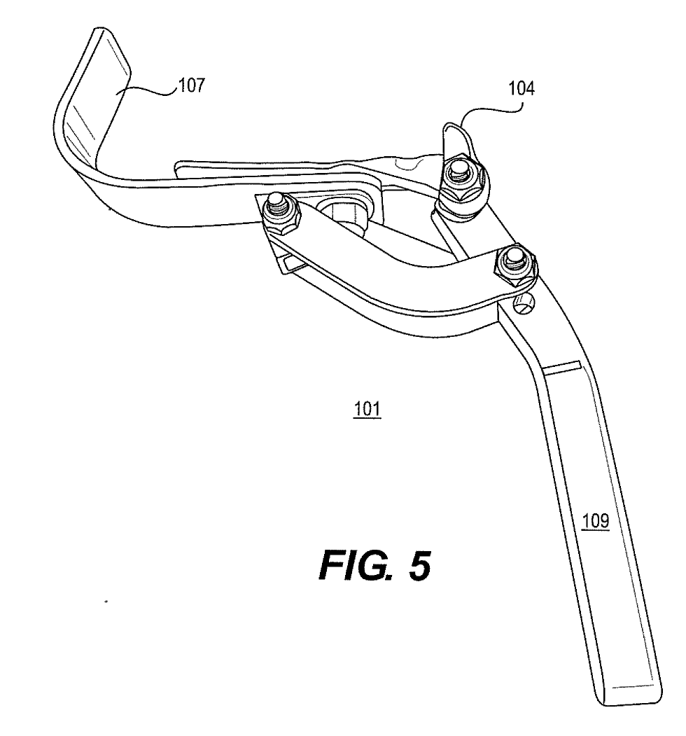

FIG. 5 shows the device 101 closed, with the first hook 104 and the second hook 107 at the closest distance to each other.

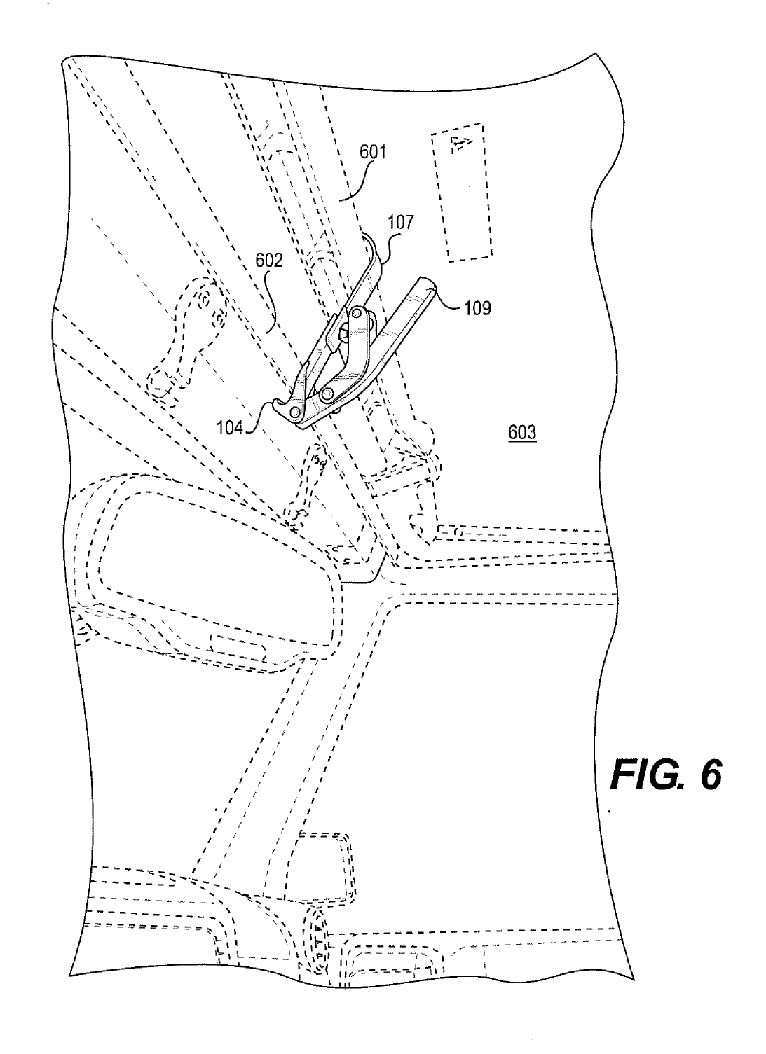

FIG. 6 shows the device 101 in position on a vehicle while in use. The device is fully extended such that the first hook 104 and the second hook 107 are at the farthest distance from each other. The first hook 104 is placed under the top frame of the windshield 602, and the second hook 107 is placed over the front edge 601 of the soft top 603. Once in place, the handle 109 may be drawn in a downward motion, thereby pulling together the top frame of the windshield 602 and the front edge 601 of the soft top 603, allowing the operator to secure the soft top on a vehicle.

This invention has been described in sufficient detail to enable those skilled in the art to practice them, and it is to be understood that changes may be made without deviating from the scope of the invention described herein.

1. A soft top assist device comprising:
A first hook portion, the first hook portion having, a flat portion and a hook end;
A second hook portion slideably connected to the first hook portion with a bolt, the second hook portion having, a flat portion and a hook end;
A lever handle pivotally connected to the first hook portion; and
Two or more connectors pivotally connected to the lever handle and the second hook portion.

2. The soft top assist device of claim 1 wherein the flat portion of the first hook portion has a slot, and where the bolt slideably connecting, the first hook portion and the second hook portion is secured through the slot such that the first hook portion and the second hook portion may move in a horizontal plane in relation to each other.

3. The soft top assist device of claim 1 wherein the hook end of the first hook portion is sized to fit under the top frame of a vehicle windshield and the hook end of the second hook portion is sized to fit over the front edge of a vehicle soft top.

4. The soft top assist device of claim 1 wherein the distance between the hook end of the first hook portion and the hook end of the second hook portion is increased or decreased by operation of the lever.

5. A soft top assist device comprising,:
A first hook portion, the first hook portion having a flat portion and a hook end;
A second hook portion slideably connected to the first hook portion with a bolt, the second hook portion having a flat portion and a hook end;
A lever handle pivotally connected to the first hook portion;
Two or more connectors pivotally connected to the lever handle and the second hook portion;
The flat portion of the first hook portion has a slot;
The bolt slideably connecting the first hook portion and the second hook portion is secured through the slot such that the first hook portion and the second hook portion may move in a horizontal plane in relation to each other;
The hook end of the first hook portion is sized to fit under the top frame of a vehicle windshield and the hook end of the second hook portion is sized to fit over the front edge of a vehicle soft top; and
wherein the distance between the hook end of the first hook portion and the hook end of the second hook portion is increased or decreased by operation of the lever.
